(19) United States
(12) Patent Application Publication
(10) Pub. No.: US 2009/0212646 A1
(43) Pub. Date: Aug. 27, 2009

(54) BALANCE MEMBER, MOTOR, AND DISK DRIVE APPARATUS

(75) Inventors: Hiroyuki Abe, Kyoto (JP); Rentaro Kanzawa, Kyoto (JP)

Correspondence Address: NIDEC CORPORATION;c/o KEATING & BENNETT, LLP, 1800 Alexander Bell Drive, SUITE 200, Reston, VA, 20191, US

(73) Assignee: NIDEC CORPORATION, Kyoto (JP)

(21) Appl. No.: 12/392,337

(22) Filed: Feb. 25, 2009

(30) Foreign Application Priority Data
Feb. 26, 2008 (JP) 2008-044110

(51) Int. Cl. H02K 5/24

(52) U.S. Cl. 310/51

(57) ABSTRACT

A balance member includes a first arc-shaped portion extending in a circumferential direction about a predetermined central axis, and a second arc-shaped portion having an end portion opposing and connected to an end portion of the first arc-shaped portion. The thickness of the first arc-shaped portion is greater than the thickness of the second arc-shaped portion.

### BACKGROUND OF THE INVENTION

1. Field of the Invention

The present invention relates to a motor having a fixed portion and a rotating portion, a disk drive including the motor, and a balance member installed to the rotating portion of the motor.

2. Description of the Related Art

In a hard disk drive or an optical disk drive, a spindle motor is mounted to rotate a disk about a central axis thereof. The spindle motor includes a fixed portion which is fixed in a housing, and a rotating portion which supports and rotates the disk. The spindle motor generates a torque in a rotational direction about the central axis thereof by the magnetic flux present between the fixed portion and the rotating portion, thereby rotates the rotating portion and the disk supported by the rotating portion.

Such a spindle motor may have a balance member to correct an eccentricity of the center of gravity of the rotating portion about the central axis. As an exemplary balance member, a C-shaped member may be used to correct an eccentricity of the center of gravity of the rotating portion by being installed thereto. To install the balance member to the rotating portion, it is abutted to the rotating portion while being bent, and then its holding is released.

A conventional balance member has a cut portion formed therein so as to be made eccentric to the opposite side of the cut portion, thereby the eccentricity of the center of gravity of the rotating portion is corrected. Thus, when it is necessary to correct a large eccentricity of the center of gravity of the rotating portion, the thickness of the opposite side of the cut portion should be made greater to make the balance member more eccentric.

However, as the thickness of the opposite side of the cut portion of the balance member becomes greater, the balance member becomes less flexible, which makes it difficult to install the balance member to the rotating portion. Further, the balance member may be plastically deformed by the force which holds it in the bent position, and not return to its original shape.

### SUMMARY OF THE INVENTION

According to a preferred embodiment of the present invention, there is provided a balance member including a first arc-shaped portion extending in a circumferential direction about a predetermined central axis, and a second arc-shaped portion having an end portion opposing and connected to an end portion of the first arc-shaped portion, wherein the thickness of the first arc-shaped portion is greater than thickness of the second arc-shaped portion.

According to another preferred embodiment of the present invention, there is provided a motor including a fixed portion, a rotating portion rotating against the fixed portion about a predetermined central axis, and a balance member locked to the rotating portion. The balance member has both end portions in a circumferential direction opposing each other and is substantially arc-shaped. At least one thickness of a first arc-shaped portion in an axial direction and a radial direction is greater than the thickness of a second arc-shaped portion positioned in the middle of the first arc-shaped portion, in the same direction.

According to yet another preferred embodiment of the present invention, there is provided a disk drive including a motor having a fixed portion, a rotating portion rotating against the fixed portion about an central axis, and a balance member installed to the rotating portion, a disk installed to the rotating portion, an access portion performing writing and/or reading information on and from the disk, and a housing receiving the motor and the access portion. The balance member is substantially arc-shaped, and has both end portions opposing each other in a circumferential direction. At least one thickness of the first arc-shaped portion in an axial direction or a radial direction is greater than the thickness of the second arc-shaped portion positioned in the middle of the first arc-shaped portion of the balance member in the same direction.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a longitudinal sectional view of a disk drive according to a first preferred embodiment of the present invention.

FIG. 2 is a longitudinal sectional view of a spindle motor according to the first preferred embodiment of the present invention.

FIG. 3 is a perspective view of a balance member according to the first preferred embodiment of the present invention.

FIG. 4 is a plan view of the balance member according to the first preferred embodiment of the present invention, as viewed from the top.

FIG. 5 shows a relationship between an eccentric direction of the center of gravity of a rotating portion and a locking direction of a balance member.

FIG. 6 shows a relationship between an eccentric direction of the center of gravity of a rotating portion and a locking direction of a balance member.

FIG. 7 is a plan view of a balance member according to a second preferred embodiment of the present invention, as viewed from the top.

FIG. 8 is a plan view of a balance member according to a third preferred embodiment of the present invention, as viewed from the top.

FIG. 9 is a longitudinal sectional view of a spindle motor where a balance member is locked according to a fourth preferred embodiment of the present invention.

FIG. 10 is a plan view of a balance member according to the fourth preferred embodiment of the present invention, as viewed from the top.

FIG. 11 is a perspective view of a balance member according to a fifth preferred embodiment of the present invention.

### DETAILED DESCRIPTION OF THE PREFERRED EMBODIMENTS

Preferred embodiments of the present invention will hereinafter be described with reference to the accompanying drawings. In the description, a term “up” indicates the side of a rotating portion 4, and a term “down” indicates the side of a fixed portion 3 in a central axis L direction. However, it is to be understood that the installation structure of a spindle motor and a disk drive according to the present invention is not limited to the disclosed embodiments.

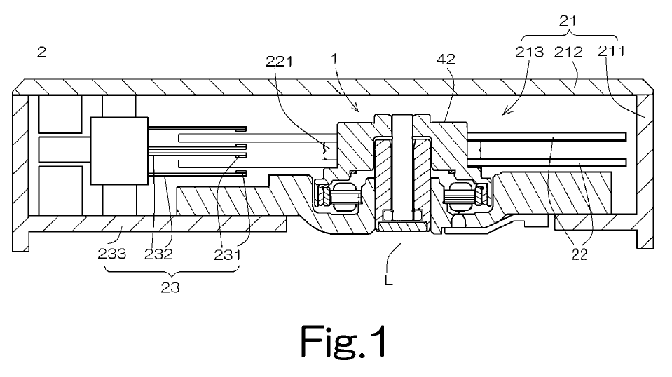

FIG. 1 is a longitudinal sectional view of a disk drive 2 according to a first preferred embodiment of the present invention. The disk drive 2 is a hard disk drive in which information is recorded on and read from magnetic disks 22 by rotating the two magnetic disks 22. As shown in FIG. 1, the disk drive 2 preferably has a housing 21, two magnetic disks (hereinafter, referred to as “disk”) 22, an access portion 23, and a spindle motor 1.

The housing 21 preferably has a cup-shaped first housing member 211, and a substantially flat-shaped second housing member 212. The first housing member 211 has an opening at the upper end. The spindle motor 1 and the access portion 23 are provided inside the first housing member 211 and are installed on the bottom surface of the first housing member 211. The second housing member 212 is coupled to the first housing member 211 so as to close the opening of the upper portion of the first housing member 211. The first housing member 211 and the second housing member 212 define an internal space 213. The internal space 213 receives the two disks 22, the access portion 23, and the spindle motor 1. The internal space 213 of the housing 21 is a clean space with little dust therein.

Each of the two disks 22 is an information storage medium having a hole at a central portion thereof, and is substantially disk-shaped. Each disk 22 is installed to a hub 42 of the spindle motor 1, and is stacked vertically with a spacer 221 interposed therebetween. Meanwhile, the access portion 23 has four heads 231 respectively facing upper surfaces or lower surfaces of the two disks 22, four arms 232 respectively supporting the heads 231, and a moving device 233 moving the arms 232. The access portion 23 preferably moves the four arms 232 along the disk 22 with the moving device 233 and enables the four heads 231 to be placed at a required position on the disk 22. In accordance with this, information is recorded on and read from a recording surface of each rotating disk 22. The head 231 may either read information from or record information on a recording surface of the disk 22.

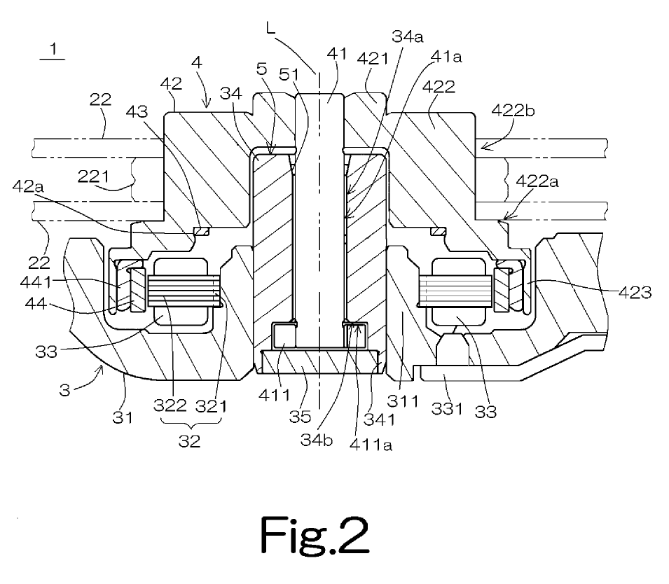

Hereinafter, the structure of the spindle motor 1 will be described. FIG. 2 shows a longitudinal sectional view of the spindle motor 1. As shown in FIG. 2, the spindle motor 1 preferably has a fixed portion 3 fixed to the housing 21 of the disk drive 2, and a rotating portion 4 locking the disk 22 and rotating about the central axis L.

The fixed portion 3 preferably has a base member 31, a stator core 32, a coil 33, and a sleeve 34.

The base member 31 is preferably made of a metal material such as aluminum and the like, and is fixed to the housing 21 of the disk drive 2 with a screw. In the base member 31, a holder portion 311 is provided. The holder portion 311 has a substantially cylindrical shape and is projected around the central axis L in an axial direction (a direction along the central axis L). An inner circumferential side of the holder portion 311 (inner circumferential side with respect to the central axis L) defined by a penetration hole preferably holds the sleeve 34. A surface of an outer circumferential side of the holder portion 311 (outer circumferential side with respect to the central axis L) is a mounting surface on which the stator core 32 is mounted by being inserted thereto.

In this preferred embodiment, the base member 31 and the first housing member 211 are provided as separate units. However, the base member 31 and first housing member 211 can be provided integrally as a single member.

The stator core 32 and the coil 33 act as a magnetic flux generator which generates magnetic flux in accordance with input drive current. The stator core 32 preferably has a substantially annular core back 321 fitted to an outer circumferential surface of the holder portion 311, and a plurality of teeth portions 322 projected outward from the core back 321 in a radial direction (a direction perpendicular to the central axis L). The stator core 32 may be provided by pressing a laminated steel sheet, e.g., an electro magnetic steel sheet laminated in the axial direction.

The coil 33 preferably includes a wire which is wound around each of the teeth portions 322 of the stator core 32. The coil 33 is connected to an external power supply (not shown) through a connector 331. When the drive current is supplied to the coil 33 through the connector 331 from the power supply, the magnetic flux is generated in the teeth portions 322 in the radial direction or axial direction. The magnetic flux generated at the teeth portions 322 generates a torque to rotate the rotating portion 4 about the central axis (L) by interaction with magnetic flux of a rotor magnet 44 which will be described later.

The sleeve 34 is a substantially cylindrical member disposed at an outer circumferential side of a shaft 41, and its inner circumferential surface 34a opposes an outer circumferential surface 41a of the shaft 41. The sleeve 34 is fixed at the inner circumferential surface of a holder portion 311 of the base member 31. A protruded portion 341 is provided by being projected downward from an edge of a lower surface of the sleeve 34. A cap 35 is fixed at the protruded portion 341 and seals the opening of a lower end of the sleeve 34.

The sleeve 34 constitutes a bearing mechanism which restricts movement of the shaft 41 in the radial and axial directions and allows the shaft 41 to rotate about the central axis L. In a minute gap (e.g., approximately a few μm) between the inner circumferential surface 34a of the sleeve 34 and the outer circumferential surface 41a of the shaft 41, or between a lower surface of the shaft 41 and an upper surface of the cap 35, lubricating fluid 51 is continuously filled with. The lubricating fluid 51 may be oil mainly containing ester such as polyol ester-based oil or diester-based oil.

It is preferable that the inner circumferential surface 34a of the sleeve 34 has radial dynamic-pressure-generating grooves (not shown) provided thereon so as to generate fluid dynamic pressure to the lubricating fluid 51 arranged between the outer circumferential surface 41a of the shaft 41 and the inner circumferential surface 34a of the sleeve 34. The radial dynamic-pressure-generating grooves may be, for example, herringbone grooves, with a plurality of hook-shaped grooves arranged along the circumferential direction. When the shaft 41 rotates against the sleeve 34, the radial dynamic-pressure-generating grooves pressurize the lubricating oil 51, and the shaft 41 rotates while being supported in a radial direction by the fluid dynamic pressure generated in the lubricating fluid 51. The radial dynamic-pressure-generating grooves may be arranged either on the inner circumferential surface 34a of the sleeve 34 or on the outer circumferential surface 41a of the shaft 41.

In addition, thrust dynamic-pressure-generating grooves (not shown) are arranged on the lower surface 34b of the sleeve 34 opposing an upper surface 411a of a flange portion 411 (as described below) so as to generate the fluid dynamic pressure to the lubricating fluid filled between the lower surface 34b of the sleeve 34 and the upper surface 411a of the flange portion 411. The thrust dynamic-pressure-generating grooves are provided as a plurality of spiral grooves about the central axis L. When the shaft 41 rotates about the sleeve 34, the thrust dynamic-pressure-generating grooves pressurize the lubricating fluid 51, and the shaft 41 rotates while being supported in the axial direction by fluid dynamic pressure generated in the lubricating fluid 51. The thrust dynamic-pressure-generating grooves can be provided on either the lower surface 34b or the upper surface 411a.

As described above, the sleeve 34 and the cap 35 act as fixed bearing members rotatably supporting the shaft 41. Preferably, the sleeve 34, the cap 35, the shaft 41, and the lubricating fluid 51 constitute a fluid dynamic-pressure bearing mechanism 5.

The sleeve 34 is made of a metal (a soluble material) such as stainless steel or copper alloy. However, the sleeve 34 can be made of other material such as sintered body which is bonded and solidified with metal powder while being heated, or various kinds of resins. In addition, the sleeve 34 can be made of more than two members. For example, the sleeve 34 may have an approximately cylindrical sleeve main body and a housing receiving the sleeve main body.

Continuously, a structure of the rotating portion 4 will be described. The rotating portion 4 preferably has the shaft 41, the hub 42, a balance member 43, and a rotor magnet 44.

The shaft 41 is a substantially cylindrical member disposed along the central axis L. The shaft 41 is rotatably supported against the sleeve 34 while being inserted into the sleeve 34 (bearing hole). The flange portion 411 having substantially an annular shape is fixed at a lower end of the shaft 41, and prevents the shaft 41 from being separated from the sleeve 34. The flange portion 411 has a projected portion projected outward from the outer circumferential surface of the shaft 41 in the radial direction. The upper surface 411a of the flange portion 411 opposes the lower surface 34b of the sleeve 34.

When a force is applied to the rotating portion 4 upwardly, the upper surface 411a of the flange portion 411 abuts on the lower surface 34b of the sleeve 34, or the upward force becomes weak by the lubricating fluid 51 filled between the lower surface 34b of the sleeve 34 and the upper surface 411a of the flange portion 411. This action prevents separation of the fixed portion 3 and the rotating portion 4. In this preferred embodiment of the present invention, the shaft 41 and the flange portion 411 are provided of separated members. However, the shaft 41 and the flange portion 411 can be integrally provided as a single member.

The hub 42 preferably is fixed to and rotates with the shaft 41, and expands outward in the radial direction around the central axis L. The hub 42 preferably has a connecting portion 421, a body portion 422, and a cylindrical portion 423. For example, the connecting portion 421 may be connected to the upper end of the shaft 41 by press fitting or shrink fitting, or the like. The body portion 422 radially expands outward and downward from the connecting portion 421. The cylindrical portion 423 preferably extends downward from the circumferential edge of the body portion 422. The hub 42 having the above-described structure preferably covers an upper portion of the stator core 32, the coil 33, and the sleeve 34.

The body portion 422 of the hub 42 is provided with a first supporting surface 422a and a second supporting surface 422b provided thereon to support the disk 22. The first supporting surface 422a is a substantially horizontal plane supporting the disk 22 from the lower side. The second supporting surface 422b is an approximately cylindrical surface which abuts an inner circumferential edge of the two disks 22, and regulates the movement of the two disks 22 in radial direction. Among the two disks 22, the lower disk 22 is disposed on the first supporting surface 422a, and the upper disk 22 is disposed above the lower disk with a spacer 211 disposed therebetween.

The hub 42 is made of a metal material such as aluminum, magnetic SUS (stainless), and a cold rolled steel sheet (SPCC, SPCD, SPCE), for example. In this preferred embodiment of the present invention, the hub 42 is provided as single member, but the hub 42 can be provided of more than two members. For example, the hub 42 may be made integral by firmly combining members equivalent to the connecting portion 421, the body portion 422, and the cylindrical portion 423.

The balance member 43 is preferably arranged to control the eccentricity of the center of gravity of the rotating portion 4 about the central axis L. In this preferred embodiment of the present invention, the balance member 43 is substantially arc shaped where both end portions thereof in the circumferential direction oppose each other. That is, the balance member 43 is substantially C-shaped. As shown in FIG. 2, the balance member 43 is locked to the hub 42 while its outer circumferential edge is abutted to a ring-shaped recessed portion 42a provided on the inner circumferential surface of the hub 42. The balance member 43 preferably controls the eccentricity of the center of gravity of the rotating portion 4 by being locked to the hub 42, and improves rotational accuracy of the rotating portion 4 about the central axis L.

The rotor magnet 44 is installed on the inner circumferential surface of the cylindrical portion 423 of the hub 42 through a yoke 411. The rotor magnet 44 is disposed annularly so as to encompass the central axis L. The inner circumferential surface of the rotor magnet 44 is a magnetic pole surface, and opposes the outer circumferential surface of the plurality of teeth portions 322 of the stator core 32.

In the spindle motor 1, when a drive current is applied to the fixed portion 3 of the coil 33, the magnetic flux is generated at the teeth portions 322 of the stator core 32 in an axial or radial direction. Then, a torque is generated by the magnetic flux present between the teeth portions 322 and the rotor magnet 44, and the rotating portion 4 rotates against the fixed portion 3 about the central axis L. The two disks 22 supported on the hub 42 preferably rotate with the shaft 41 and the hub 42 about the central axis L.

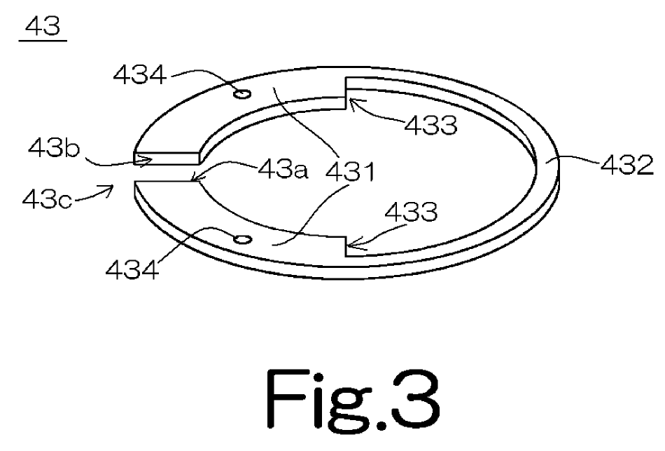

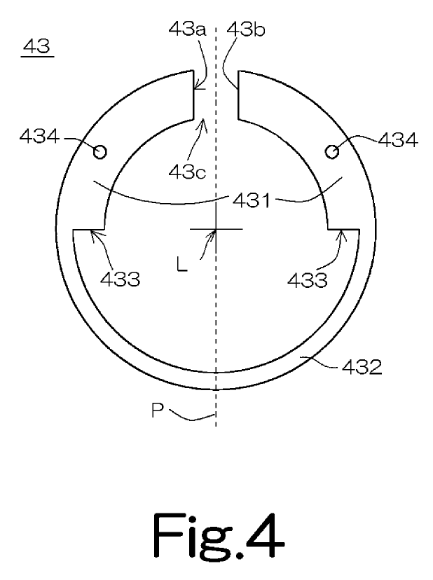

FIG. 3 is a perspective view and FIG. 4 is a plan view (viewed from the top) of the balance member 43 according to this preferred embodiment of the present invention. As shown in FIGS. 3 and 4, the balance member 43 is substantially arc-shaped (C-shaped) where one end portion 43a opposes the other end portion 43b in the circumferential direction. Specifically, the shape of the balance member 43 includes a ring shape with a cut portion 43c provided therein.

The balance member 43 has a first arc-shaped portion 431 and a second arc-shaped portion 432 having a different thickness from the arc-shaped portion 431 in a radial direction. The first arc-shaped portion 431 is a portion of an arc-shaped member having the both end portion 43a and 43b of the balance member 43, and the second arc-shaped portion 432 is a portion of an arc-shaped member positioned in the middle of the first arc-shaped portion 431. As shown in FIGS. 3 and 4, the thickness of the portion of the balance member 43 including the both end portions 43a and 43b (a first arc-shaped portion 431) is greater than the thickness of the other portion (a second arc-shaped portion 432). At a boundary between the first arc-shaped portion 431 and the second arc-shaped portion 432, a stepped portion 433 is provided. The first arc-shaped portion 431 having relatively large thickness is adjacent to the second arc-shaped portion 432 having relatively small thickness through the stepped portion 433.

In the first arc-shaped portion 431 of the balance member 43, a pair of holding holes 434 are provided so as to hold the balance member 43 when the balance member 43 is installed to the hub 42. When installing the balance member 43 to the hub 42, predetermined jigs are inserted to a pair of holding holes 434, and then the balance member 43 is bent inward. This is performed by applying a force to make the pair of holding holes 434 approach one another. Thereafter, by abutting the balance member 43 to a recessed portion 42a in the inner circumferential surface of the hub 42, and releasing the holding provided by the jigs, the balance member 43 is installed to the hub 42.

The balance member 43 may be obtained preferably by pressing a metal material such as stainless steel or aluminum. However, the materials constituting the balance member 43 or processing method thereof is not limited to the above mentioned material or processing method. The material forming the balance member 43 may be a synthetic resin such as rubber and the like, or a composite material such as ceramics and the like, and may be other materials having a certain mass density and flexibility. In addition, the processing method for balance member 43 is not limited to pressing. In addition to pressing, other processing methods, for example, cutting, casting, injection molding can be used.

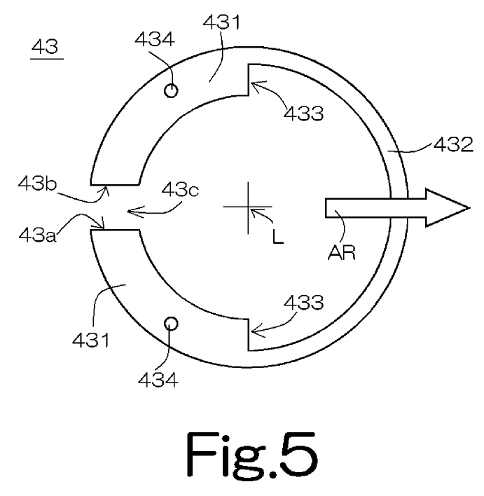

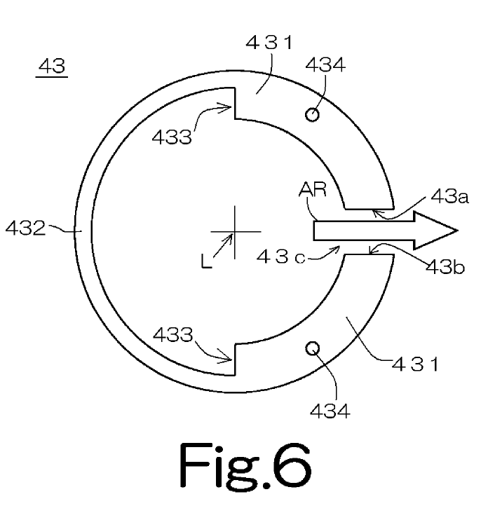

As described above, the radial thickness of the first arc-shaped portion 431 of the balance member 43 is larger than the radial thickness of the second arc-shaped portion 432. Therefore, the weight of the balance member 43 is unevenly distributed and becomes eccentric to the side of the first arc-shaped portion 431. Therefore, by locking the balance member 43 to the hub 42, the eccentricity of the center of gravity of the rotating portion 4 can be effectively controlled. For example, as shown in FIG. 5, if the center of gravity of the rotating portion 4 becomes eccentric toward an arrow direction AR and it is required to reduce the eccentricity, the balance member 43 is installed to the hub 42 so that the cut portion 43c faces the opposite direction of the arrow AR. Thereby, the eccentricity of the center of gravity of the rotating portion 4 is reduced, because the weight of the first arc-shaped portion 431 is applied to the opposite side of the eccentricity of the center of gravity of the rotating portion 4 about the central axis L. In contrast, if the eccentricity of the center of gravity of the rotating portion 4 is required to be intentionally increased, as shown in FIG. 6, the balance member 43 is installed to the hub 42 so that the cut portion 43c of the balance member 43 faces the arrow AR direction. Thereby, the eccentricity of the center of gravity of the rotating portion 4 is increased, because the weight of the first arc-shaped portion 431 is applied to the same side with the eccentricity of the center of gravity of the rotating portion 4 about the central axis L.

In addition, the balance member 43 has high flexibility since the second arc-shaped portion 432 of the balance member 43 is thinner than the first arc-shaped portion 431 in the radial direction. Therefore, when installing the balance member 43 to the hub 42, the balance member 43 can be easily bent and installed.

Furthermore, as shown in FIG. 4, the balance member 43 according to this preferred embodiment of the present invention includes a symmetric shape about a plane passing through a central position between the both end portions 43a and 43b of the balance member 43, and the central axis L. Therefore, the balance member 43 is eccentric to the cut portion 43c. When installing the balance member 43 to the hub 42, a direction of the balance member 43 is determined according to the position of the cut portion 43c. Therefore, the eccentricity of the center of gravity of the rotating portion 4 can be effectively controlled.

The balance member 43 according to this preferred embodiment of the present invention is used in the spindle motor 1 rotating the magnetic disk (hard disk) 22. This kind of spindle motor 1 is required to have high rotational accuracy and to be very clean. Because of this, the balance member 43 according to this preferred embodiment of the present invention can be eccentric to the cut portion 43c without damaging flexibility. Therefore, the rotational vibration of the spindle motor 1 about the central axis L can be effectively controlled. In addition, the method for controlling the balance member 43 according to this preferred embodiment of the present invention does not generate dust, unlike in the case of drilling the hub 42. Therefore, the cleanness of the spindle motor 1 can be maintained, while improving the rotational accuracy of the spindle motor 1.

A pair of the holding holes 434 can be provided not only in the first arc-shaped portion 431, but also in the second arc-shaped portion 432. However, to bend the balance member 43 with less force, it is preferable that a pair of the holding holes 434 is provided in the first arc-shaped portion 431 near the cut portion 43c. In addition, it is preferable that a pair of the holding holes 434 are provided at the side of the first arc-shaped portion 431 having relatively greater thickness where the holes can be easily provided.

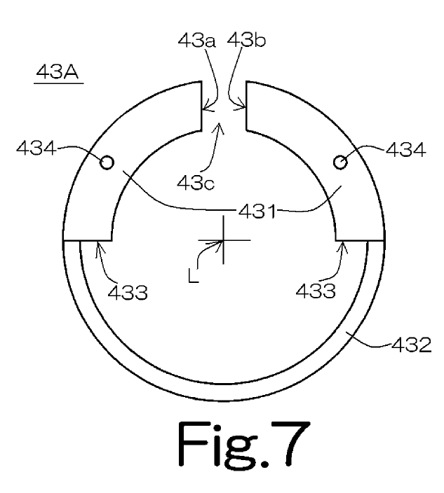

FIG. 7 shows a balance member 43A according to a second preferred embodiment of the present invention. In the second preferred embodiment of the present invention, the balance member 43A is not provided as a single member, instead a plurality of members constitute the balance member 43A. As shown in FIG. 7, the first arc-shaped portion 431 and the second arc-shaped portion 432 are provided separately, and the balance member 43A is made by fixing the first arc-shaped portion 431 and the second arc-shaped portion 432 to each other through welding, etc. In this case, if the first arc-shaped portion 431 is made of a material having relatively high mass density, the balance member 43A can become largely eccentric toward the side of the first arc-shaped portion 431. In addition, if the second arc-shaped portion 432 is made of a material having high flexibility, the balance member 43A can be easily bent when locked to the hub 42. A method for fixing the first arc-shaped portion 431 and the second arc-shaped portion 432 is not limited specifically, but may be methods using glue, locking structures (hook, etc.), caulking, etc. The first arc-shaped portion and the second arc-shaped portion may be respectively made of different materials. The first arc-shaped portion may be made of a plurality of members and the second arc-shaped portion may be made of a plurality of members. In this case, a method for fixing each member is not limited to any specific method. In addition, materials used in the members which constitute the first arc-shaped portion and materials used in the members which constitute the second arc-shaped portion may be different.

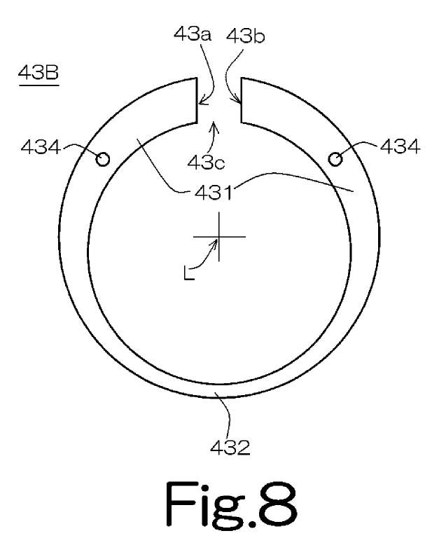

FIG. 8 shows a balance member 43B according to a third preferred embodiment of the present invention. In the third preferred embodiment of the present invention, the first arc-shaped portion 431 and the second arc-shaped portion 432 is connected smoothly and continuously without the stepped portion 433. The farther from the end portions 43a and 43b, the smaller the thickness of the balance member 43B in a radial direction, and the nearer to the end portions 43a and 43b, the greater the thickness of the balance member 43B. In this case, a pair of arc-shaped portions having a predetermined length including the both end portions 43a and 43b can be regarded as the first arc-shaped portion 431, and an arc-shaped portion positioned in the middle of the first arc-shaped portion 431 can be regarded as the second arc-shaped portion 432. If the balance member 43B has the above-described shape in this embodiment of the present invention, high flexibility can be obtained, because the average thickness of the first arc-shaped portion 431 is greater than the average thickness of the second arc-shaped portion 432.

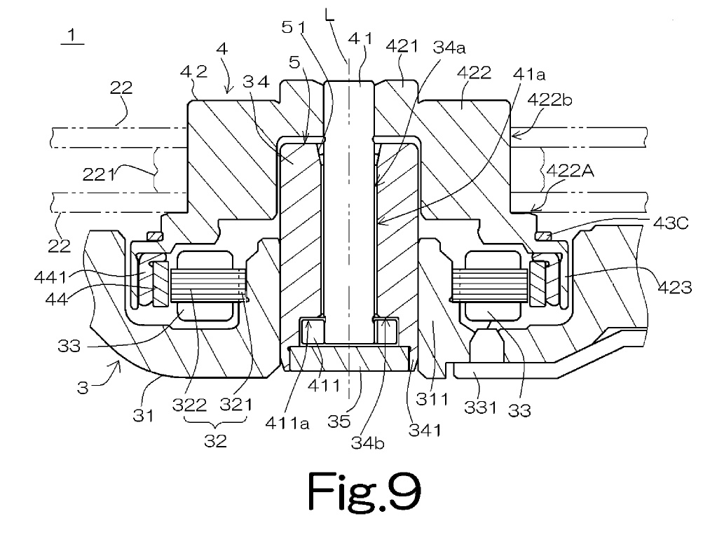

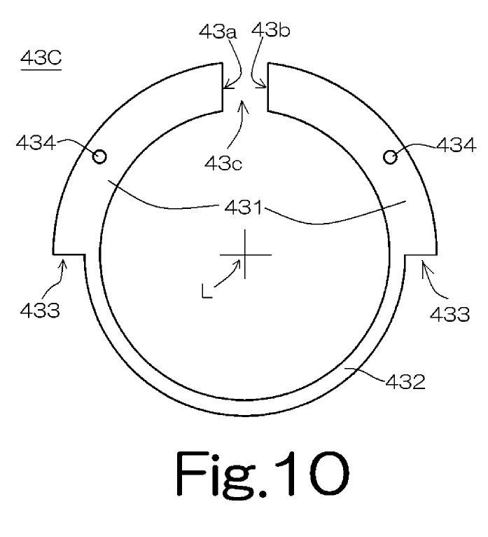

FIG. 9 and FIG. 10 show a spindle motor and a balance member 43C according to a fourth preferred embodiment of the present invention. As shown in FIG. 9, in the fourth preferred embodiment of the present invention, the balance member 43C is installed an outer circumferential side of the hub 42. As shown in FIG. 10, when the balance member 43C is installed on the outer circumferential side of the hub 42, a first arc-shaped portion 431 of the balance member 43C is projected outward and an edge of the inner circumference of the balance member 43C is arc-shaped without a stepped portion. In accordance with this, the balance member 43C is firmly installed to the outer circumferential side of the hub 42.

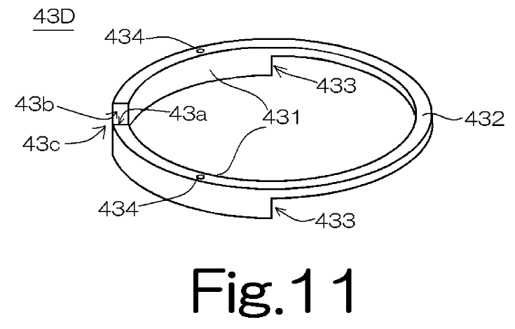

FIG. 11 shows a balance member 43D according to a fifth preferred embodiment of the present invention. The axial thickness of the balance member 43D may be differed at a first arc-shaped portion 431 and a second arc-shaped portion 432. As shown in FIG. 11, the axial thickness of the first arc-shaped portion 431 of the balance member 43D is greater than the axial thickness of the second arc-shaped portion 432. With this shape, flexibility of the balance member 43D at the second arc-shaped portion 432 can be maintained, and the balance member 43D can be eccentric to a cut portion 43c. Therefore, the balance member 43D can be easily installed to the hub 42 of the spindle motor 1, and the eccentricity of the center of gravity of the rotating portion 4 can be effectively controlled.

In each preferred embodiment of the present invention, the thickness of the first arc-shaped portion 431 and the second arc-shaped portion 432 can be different in axial and radial directions. Namely, at least one thickness of the first arc-shaped portion 431 in an axial or radial direction needs to be greater than the thickness of the second arc-shaped portion 432 in the same direction.

In the respective preferred embodiments of the present invention, shapes of the balance member are not limited to the above-described shapes. Fox example, the thickness of the first arc-shaped portion or the second arc-shaped portion in a radial direction does not have to be equal over the entire balance member in a circumferential direction. Namely, as viewed from a plan view, the shape of outer circumferential surface of the balance member and the shape of inner circumferential surface abutting on the hub 42 can be substantially polygon or substantially ellipse, and are not limited to a certain shape. In addition, the thickness of the first arc-shaped portion in an axial direction does not have to be equal over the entire balance member in a circumferential direction, and may have a recessed portion or projected portion provided therein.

In the first preferred embodiment and other preferred embodiments of the present invention, a pair of holding holes 434 can be provided not only in the first arc-shaped portion 431 but also in the second arc-shaped portion 432.

The above-described preferred embodiments of the present invention relate to a “shaft-rotating” type spindle motor 1 where the shaft 41 rotates with the hub 42. However, the present invention can be applied to a “shaft-fixed” type spindle motor where the sleeve and the hub rotate relative to the fixed shaft. In the case of the “shaft-fixed” type spindle motor, the fixed portion is preferably constituted of the base member, the stator core, the coil, and the shaft. In addition, the rotating portion is preferably constituted of the sleeve, the hub, the balance member, and the rotor magnet. In the above-described preferred embodiments of the present invention, two disks 22 are held on the hub 42, but the number of the disks 22 is not limited to two.

Additionally, the above-described preferred embodiments of the present invention relate to the spindle motor 1 rotating the magnetic disk 22. However, the present invention can be applied to a general motor having a fixed portion and a rotating portion. For example, the present invention can be applied to a spindle motor, a fan motor, etc. which rotates other types of information recording medium such as an optical disk, etc.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A balance member comprising:
a first arc-shaped portion extending in a circumferential direction about a central axis; and
a second arc-shaped portion extending in the circumferential direction adjacent to the first arc-shaped portion; wherein
a thickness of the first arc-shaped portion is greater than a thickness of the second arc-shaped portion.

2. The balance member of claim 1, wherein the thickness of the first arc-shaped portion in a radial direction of the central axis is greater than the thickness of the second arc-shaped portion in the radial direction.

3. The balance member of claim 1, wherein the thickness of the first arc-shaped portion in an axial direction of the central axis is greater than the thickness of the second arc-shaped portion in the axial direction.

4. The balance member of claim 1, further comprising a stepped portion located between the first arc-shaped portion and the second arc-shaped portion.

5. The balance member of claim 1, wherein the first arc-shaped portion projects further radially inward relative to the second arc-shaped portion.

6. The balance member of claim 1, wherein the first arc-shaped portion projects further radially outward relative to the second arc-shaped portion.

7. The balance member of claim 1, wherein a material of the first arc-shaped portion has a higher mass density than a material of the second arc-shaped portion.

8. The balance member of claim 1, further comprising a hole provided in the first arc-shaped portion.

9. The balance member of claim 1, further comprising a hole provided in the second arc-shaped portion.

10. The balance member of claim 1, wherein the balance member is substantially symmetrical about a plane passing through a position centered between first and second end portions of the first arc-shaped portion and the central axis.

11. The balance member of claim 1, wherein the first arc-shaped portion and the second arc-shaped portion are separate members.

12. The balance member of claim 1, wherein the first arc-shaped portion and the second arc-shaped portion are unitary members which are continuously and seamlessly connected to each other.

13. The balance member of claim 1, wherein the first arc-shaped portion and the second arc-shaped portion are made of a metal, a synthetic resin, or a composite material.

14. The balance member of claim 1, further comprising a cut portion provided between first and second ends of the first arc-shaped portion.

15. A motor comprising:
a fixed portion;
a rotating portion arranged to rotate relative to the fixed portion about a central axis; and
a balance member locked to the rotating portion; wherein
the balance member is substantially arc-shaped and has first and second end portions opposing each other in a circumferential direction, the balance member includes a first arc-shaped portion and a second arc-shaped portion, the second arc-shaped portion is positioned in a middle of the first arc-shaped portion in the circumferential direction, and a thickness of the first arc-shaped portion in at least one of an axial direction and a radial direction of the central axis is greater than a thickness of the second arc-shaped portion in the axial direction and the radial direction, respectively.

16. The motor of claim 15, wherein the rotating portion includes a recessed portion, and the balance member is locked to the recessed portion.

17. The motor of claim 15, wherein the balance member is locked to an inner side of the rotating portion.

18. The motor of claim 15, wherein the balance member is locked to an outer side of the rotating portion.

19. The motor of claim 15, wherein at least one hard disk is locked to the rotating portion.

20. A disk drive apparatus comprising:
a motor including a fixed portion, a rotating portion arranged to rotate relative to the fixed portion about a central axis, and a balance member installed on the rotating portion;
a disk installed on the rotating portion;
an access portion arranged to write and/or read information on and from the disk; and
a housing accommodating therein the motor and the access portion; wherein
the balance member is substantially arc-shaped and has first and second end portions opposing each other in a circumferential direction, the balance member includes a first arc-shaped portion and a second arc-shaped portion, the second arc-shaped portion is positioned in a middle of the first arc-shaped portion in the circumferential direction, and a thickness of the first arc-shaped portion in at least one of an axial direction and a radial direction of the central axis is greater than a thickness of the second arc-shaped portion in the axial direction and the radial direction, respectively.
